(19) United States
(12) Patent Application Publication
(10) Pub. No.: US 2013/0288122 A1
(43) Pub. Date: Oct. 31, 2013

(54) COPPER FOIL FOR NEGATIVE ELECTRODE CURRENT COLLECTOR OF LITHIUM ION SECONDARY BATTERY, NEGATIVE ELECTRODE MATERIAL OF LITHIUM ION SECONDARY BATTERY, AND METHOD FOR SELECTING NEGATIVE ELECTRODE CURRENT COLLECTOR OF LITHIUM ION SECONDARY BATTERY

(71) Applicants: Hideaki Matsushima, Ageo-shi (JP); Sakiko Tomonaga, Shinjuku-ku (JP); Koichi Miyake, Kitamoto-shi (JP)

(72) Inventors: Hideaki Matsushima, Ageo-shi (JP); Sakiko Tomonaga, Shinjuku-ku (JP); Koichi Miyake, Kitamoto-shi (JP)

(73) Assignee: MITSUI MINING & SMELTING CO., LTD., Tokyo (JP)

(21) Appl. No.: 13/885,540

(22) PCT Filed: Nov. 8, 2011
(86) PCT No.: PCT/JP2011/075716

§ 371 Date: Jul. 3, 2013

(30) Foreign Application Priority Data
Nov. 17, 2010 (JP) 2010-257177

(51) Int. Cl. H01M 4/66; H01M 4/04

(52) U.S. Cl. CPC H01M 4/661; H01M 4/04
USPC 429/211; 29/623.1

(57) ABSTRACT

A copper foil for a negative electrode current collector of a lithium ion secondary battery enables prevention of deformation of the current collector even if the charge/discharge operation is repeatedly carried out. In a copper foil for a negative electrode current collector of a lithium ion secondary battery, a 10 mm wide test specimen composed of the copper foil is subjected to a tensile test, a maximum strain loaded on the copper foil is 30 N or higher in a region where “Value L” represented by the following expression is 0.8 or more in a strain-stress curve obtained in the tensile test where O is the starting point of the curve, P_{Q} is the load at a point Q on the curve and E_{Q} is an elongation at a point Q on the curve

$$Value L = \frac{( area of triangle {OQE}_{Q} )}{( area of region {OQE}_{Q} )} \\ … \qquad ( 1 )$$

### TECHNICAL FIELD

The present invention relates to a copper foil for a negative electrode current collector of a lithium ion secondary battery, a negative electrode material of a lithium ion secondary battery, and a method for selecting a negative electrode current collector of a lithium ion secondary battery, particularly to a copper foil for a negative electrode current collector of a lithium ion secondary battery which prevents deformation and fracture of the current collector caused by charge/discharge operation, a negative electrode material of a lithium ion secondary battery, and a method for selecting a negative electrode current collector of a lithium ion secondary battery.

### BACKGROUND ART

Conventionally, a lithium ion secondary battery in which charge/discharge operation is carried out by lithium ion transfer between a positive electrode and a negative electrode is known. The lithium ion secondary batteries are broadly utilized as power sources of portable electronic devices and the like because of a high capacity and a high energy density without the memory effect and the like.

A copper foil is used as negative electrode current collectors of lithium ion secondary batteries in general. As the copper foil, for example, an electro-deposited copper foil or a rolled copper foil is used. Configuration of a negative electrode material of a lithium ion secondary battery is finished by providing a negative electrode mixture layer containing a negative electrode active substance, a conductive material, a binder and the like on a surface of a copper foil as the current collector (for example, see Japanese Patent Laid-Open No. 2007-200686). As the negative electrode active substance, carbon-based materials such as graphite capable of absorbing/desorbing lithium ions have been used, and in recent years, silicon-based materials or tin-based materials having a larger theoretical capacity than graphite-based materials have been proposed as next-generation negative electrode active substances.

Above exemplified negative electrode active substance absorbs/desorbs lithium in the charge/discharge operation, but volume changes in the operation. As a negative electrode mixture layer expands/contracts along with volume changes of the negative electrode active substance, a stress is loaded between the negative electrode mixture layer and the current collector because the negative electrode mixture layer tightly contacts with a surface of a current collector. If deformation such as wrinkles is generated on the current collector because of expanded current collector caused by the repetition of the charge/discharge operation, short-circuit may occur between a positive electrode and a negative electrode, and a change in the distance between the positive electrode and the negative electrode may inhibits a uniform electrode reaction to decrease the charge/discharge operation durability. If fracture occurs in the current collector, problems including decrease in the capacity per unit volume and poor battery performance of a lithium ion secondary battery may occur. Since silicon-based materials and tin-based materials show larger volume changes in the charge/discharge operation than graphite-based materials, when a silicon-based material or a tin-based material is employed as a negative electrode active substance, the problem is made remarkable.

### DOCUMENT CITED

### Patent Document

[Patent Document 1] Japanese Patent Laid-Open No. 2007-200686

### SUMMARY OF THE INVENTION

### Problems to be Solved

An object of the present invention is to provide a copper foil for a negative electrode current collector of a lithium ion secondary battery which prevents deformation and fracture of the current collector even if the charge/discharge operation is repeated, a negative electrode material of a lithium ion secondary battery, and a method for selecting a negative electrode current collector of a lithium ion secondary battery.

### Means to Solve the Problem

As a result of extensive studies, the present inventors have solved above-mentioned problem by employing the copper foil described later for a negative electrode current collector of a lithium ion secondary battery, and a negative electrode material of a lithium ion secondary battery, and have found a method for selecting a suitable copper foil as a negative electrode current collector of a lithium ion secondary battery also.

A copper foil for a negative electrode current collector of a lithium ion secondary battery is characterized in when a 10 mm wide test specimen composed of the copper foil is subjected to a tensile test, a maximum strain loaded on the copper foil is 30 N or higher in a range where “Value L” represented by the following expression (1) is 0.8 or more in a strain-stress curve obtained in the tensile test wherein the starting point of the curve is taken as O, and a point on the curve where the load at an elongation of E_{Q} is P_{Q} is taken as Q.

$$\begin{matrix}[ Expression 1 ] & \\ Value L = \frac{( area of triangle {OQE}_{Q} )}{( area of region {OQE}_{Q} )} & ( 1 )\end{matrix}$$

Note that in the expression (1), the triangle OQE_{Q} indicates a triangle having corners at the starting point O, the point Q and the point E_{Q} in the stress-strain curve. The region OQE_{Q} indicates a region surrounded by a curve OQ in the stress-strain curve, a line QE_{Q} and a line OE_{Q}. “Value L” is a value to evaluate the linearity of the stress-strain curve. When the areas of the triangle OQE_{Q} and the region OQE_{Q} shown in above expression are equal, “Value L” of “1” indicates a highest linearity of a stress-strain curve.

In the copper foil for a negative electrode current collector of a lithium ion secondary battery according to the present invention, “Value L” is preferably 0.8 or more when strain loaded on the test specimen is 30 N or less. Further, a strain loaded on the test specimen is more preferably 40 N or less in a range where “Value L” is 0.8 or more.

In the copper foil for a negative electrode current collector of a lithium ion secondary battery according to the present invention, a maximum strain loaded on the copper foil after subjecting to a heat treatment at 70° C. to 450° C. is preferably 30 N or more when “Value L” is 0.8 or more.

In the copper foil for a negative electrode current collector of a lithium ion secondary battery according to the present invention, a surface roughness (Ra) of each surface are preferably in the range of 0.2 μm to 0.7 μm.

The negative electrode material of a lithium ion secondary battery according to the present invention is characterized in including the copper foil for a negative electrode current collector of a lithium ion secondary battery described above and a negative electrode mixture layer including a negative electrode active substance provided on a surface of the current collector.

In the negative electrode material of a lithium ion secondary battery according to the present invention, a material containing at least one element selected from the group consisting of B, Al, Ga, In, C, Si, Ge, Sn, Pb, Zn and Ag is preferably used as the negative electrode active substance. Particularly, a material containing Si or Sn, which has a large theoretical capacity, among all is more preferably used.

The method for selecting a negative electrode current collector of a lithium ion secondary battery to select a copper foil used for the negative electrode current collector of the lithium ion secondary battery is characterized in that any one of the copper foil for a negative electrode current collector of a lithium ion secondary battery described above is selected as a current collector among copper foils proposed.

### Advantage of the Invention

When the copper foil according to the present invention is used as a current collector for a negative electrode of a lithium ion secondary battery, the current collector follows expansion/contraction of a negative electrode mixture layer even when a material such as Si or Sn having a large theoretical capacity is employed as a material to absorb lithium or to alloy with lithium for a negative electrode active substance, and the negative electrode mixture layer greatly expands/contracts due to charge/discharge operation. As a result, a current collector prevents generation of deformation such as wrinkles and fracture in the repeated charge/discharge operation. Therefore, when the copper foil according to the present invention as a current collector for a negative electrode of a lithium ion secondary battery is used, the lithium ion secondary battery can achieve a much higher energy density and a higher capacity, and can achieve a long life.

### BRIEF DESCRIPTION OF DRAWINGS

FIG. 1 is a stress-strain curve to demonstrate “Value L” indicating the selection criterion or the performance of the copper foil for a negative electrode current collector of a lithium ion secondary battery according to the present invention.

FIG. 2 is a diagram showing stress-strain curves of electro-deposited copper foils prepared in Examples 1 to 3 and Comparative Example.

FIG. 3 is a diagram in which “Values L” are plotted against corresponding strains loaded on the test specimens.

FIG. 4 is: an X-ray-CT image(a) obtained by photographing a cross-section of a deformation-evaluation cell 1-1 prepared in Example 1; an X-ray-CT image(b) obtained by photographing a cross-section of a deformation-evaluation cell 2-1 prepared in Example 2; an X-ray-CT image(c) obtained by photographing a cross-section of a deformation-evaluation cell 3-1 prepared in Example 3; and an X-ray-CT image(d) obtained by photographing a cross-section of a deformation-comparative cell 1-1 prepared in Comparative Example.

FIG. 5 is: an X-ray-CT image (a) obtained by photographing a cross-section of a deformation-evaluation cell 1-2 prepared in Example 1; an X-ray-CT image (b) obtained by photographing a cross-section of a deformation-evaluation cell 2-2 prepared in Example 2; an X-ray-CT image (c) obtained by photographing a cross-section of a deformation-evaluation cell 3-2 prepared in Example 3; and an X-ray-CT image (d) obtained by photographing a cross-section of a deformation-evaluation cell 1-2 prepared in Comparative Example.

FIG. 6 is a diagram showing a deformation ratio after one cycle of the charge/discharge operation of each electro-deposited copper foil used as current collectors of Examples and Comparative Example.

FIG. 7 is a photograph showing an appearance of a current collector after one cycle of the charge/discharge operation of a deformation-evaluation cell 3-2 prepared in Example 3.

FIG. 8 is a photograph showing an appearance of a current collector after one cycle of the charge/discharge operation of a deformation-comparative cell 1-1 prepared in Comparative Example.

### PREFERRED EMBODIMENT OF THE INVENTION

Hereinafter, preferred embodiments of the copper foil for a negative electrode current collector of a lithium ion secondary battery, the negative electrode material of a lithium ion secondary battery, and the method for selecting a negative electrode current collector of a lithium ion secondary battery, according to the present invention will be described.

### <Lithium Ion Secondary Battery>

Basic construction: In a popular lithium ion secondary battery, a positive electrode material and a negative electrode material these are formed in a web shape are integrally wound via a separator, and the wound body is packed in a square or cylindrical case. A laminate-type lithium ion secondary batteries are used also in which a positive electrode material and a negative electrode material formed in a rectangular shape and facing each other via a separator are made one set of cell, or a plurality of the sets of cells are laminated and covered with a laminate material. Since lithium ions are high in reactivity with water, a nonaqueous electrolytic solution is usually used as an electrolytic solution.
Electrode reaction: In the electrode reaction of a lithium ion secondary battery, lithium ions (Li⁺) transfer from a positive electrode side to a negative electrode side through a separator, and are absorbed in a negative electrode mixture layer of the negative electrode side for charging. Next, lithium ions are desorbed from the negative electrode mixture layer, transfer to the positive electrode side through the separator, and are absorbed in a positive electrode mixture layer for discharging. In the present application, the electrode materials (positive electrode material, negative electrode material) mainly refer to materials constituting electrodes, and materials used in manufacturing of electrodes, and sometimes refer to electrodes as single parts. In contrast, in the present application, electrodes (positive electrode, negative electrode) mainly refer to electrode materials being capable of involving electrode reactions, or electrodes as constituting parts being assembled as a lithium ion secondary battery.
Positive electrode material: Configuration of a positive electrode material is finished by providing a positive electrode mixture layer (or a positive electrode active substance layer) on at least one side surface of a current collector for a positive electrode formed in a specific shape. Configuration of the positive electrode mixture layer is finished to include a positive electrode active substance, a conductive material, a binder and the like. The positive electrode active substance used is, for example, a lithium transition metal composite oxide. The lithium transition metal composite oxide may be LiCoO₂, LiNiO₂, LiMn₂O₄, LiMnO₂, LiCo_{0.5}Ni_{0.5}O₂, LiNi_{0.7}Co_{0.2}Mn_{0.1}O₂, LiNi_{1/3}CO_{1/3}Mn_{1/3}O₂, or the like. Note that, the positive electrode active substance is not limited to these exemplified lithium transition metal composite oxides. The positive electrode active substance can be used alone or in combination of two or more.

The positive electrode mixture layer is manufactured by suspending the positive electrode active substance, a conductive material and a binder in a suitable solvent to prepare a positive electrode mixture, applying the positive electrode mixture on a surface of a current collector such as an aluminum foil, followed by drying and optional anneal treatment, and then subjecting to rolling, pressing or the like. The conductive material may be acetylene black or the like. The binder may be polyvinylidene fluoride or the like.

Negative electrode material: Configuration of a negative electrode material is finished by providing a negative electrode mixture layer on at least one side surface of a current collector for a negative electrode formed in a specific shape. Configuration of the negative electrode mixture layer is finished to include a negative electrode active substance, a conductive material, a binder and the like. The conductive material may be acetylene black, Ketjen black, graphite or the like. The binder may be polyamic acid (polyimide), polyvinylidene fluoride, a styrene butadiene rubber, polyethylene, an ethylene propylene diene monomer, polyurethane, polyacrylic acid, polyvinyl ether, polyamideimide, or the like. The negative electrode mixture layer is manufactured, as in preparation of the positive electrode mixture layer, by suspending a negative electrode active substance described below, a conductive material and a binder in a suitable solvent to prepare a negative electrode mixture, providing the negative electrode mixture on the surface of the current collector according to the present invention, followed by drying and optional anneal treatment, and then subjecting to rolling, pressing or the like. However, the manufacturing method of a negative electrode material is not especially limited, and a negative electrode material can also be manufactured by a sputter method or a vapor deposition method.
Negative electrode active substance: The present invention uses a material absorbs/desorbs lithium ion (including materials alloying/dealloying with lithium, hereinafter the same) as a negative electrode active substance. Specifically, the negative electrode active substance includes materials containing at least one element selected from the group consisting of B, Al, Ga, In, C, Si, Ge, Sn, Pb, Zn and Ag. Here, these materials containing at least one element selected from the group consisting of B, Al, Ga, In, C, Si, Ge, Sn, Pb, Zn and Ag may be an element itself, or may be oxides or nitrides containing at least one element, or may be alloys containing these elements. Particularly, since Si and Sn have a higher theoretical capacity than carbon-based materials conventionally used as negative electrode active substances, a material containing Si or a material containing Sn is suitably used as a negative electrode active substance from the viewpoint of providing a lithium ion secondary battery having a higher energy density and a higher capacity.

Here, the material containing Si refers to a material being capable of absorbing/desorbing lithium ion (including alloying/dealloying, hereinafter the same), and containing Si. The material includes, for example, silicon itself (Si), a silicon oxide, and further, an alloy of silicon with other metal elements. These materials can be used alone or as a mixture of two or more. The metal element alloying with silicon includes one or more elements selected from the group consisting of B, Cu, Ni, Co, Cr, Fe, Ti, Pt, W, No and Au. Among these metal elements, B, Cu, Ni and Co are preferable, and use of Cu and Ni is more preferable from the viewpoint of being excellent particularly in electron conductivity, and being low in a formation capability of a lithium compound. However, employment of silicon itself or a silicon oxide as a negative electrode active substance among above materials is preferable from the viewpoint of being high in absorption capability of lithium ions.

Next, materials containing Sn refer to materials being capable of absorbing/desorbing lithium ion, or being capable of alloying/dealloying with lithium, and containing Sn. The material includes, for example, a tin itself (Sn), tin oxides, and further, alloys of tin with other elements. The metal elements alloying with tin includes, for example, one or more elements selected from the group consisting of Cu, Ni, Co, Cr, Fe, Ti, Pt, W, Mo and Au. The alloy of tin with other elements more specifically includes a Sn—Co—C alloy. However, employment of tin itself or a tin oxide as a negative electrode active substance among above materials is preferable from the viewpoint of being high in the capability to absorb lithium ions.

Among above materials, Si, Sn or the like shows larger changes in the structure and/or volume in absorbing/desorbing lithium than carbon-based materials such as graphite. Since a negative electrode mixture layer is provided to tightly contact with a surface of a current collector, if volume of the negative electrode mixture layer greatly expands/contracts in the charge/discharge operation, a high load is repeatedly loaded between the negative electrode mixture layer and the current collector when the charge/discharge operation is repeated. Therefore, in a lithium ion secondary battery using Si, Sn or the like as a negative electrode active substance, a current collector expands/contracts to more easily cause deformation such as wrinkles and fracture than when a carbon-based material such as graphite is used as a negative electrode active substance.

### <Copper Foil for a Negative Electrode Current Collector of a Lithium Ion Secondary Battery>

As a result of intensive studies, the present inventors have found that the employment of a copper foil having features described below as a current collector for a negative electrode of a lithium ion secondary battery prevents deformation of the current collector to ensure the battery performance of the lithium ion secondary battery even when the charge/discharge operation is repeated. Hereinafter, the copper foil for a negative electrode current collector of a lithium ion secondary battery according to the present invention will be described.

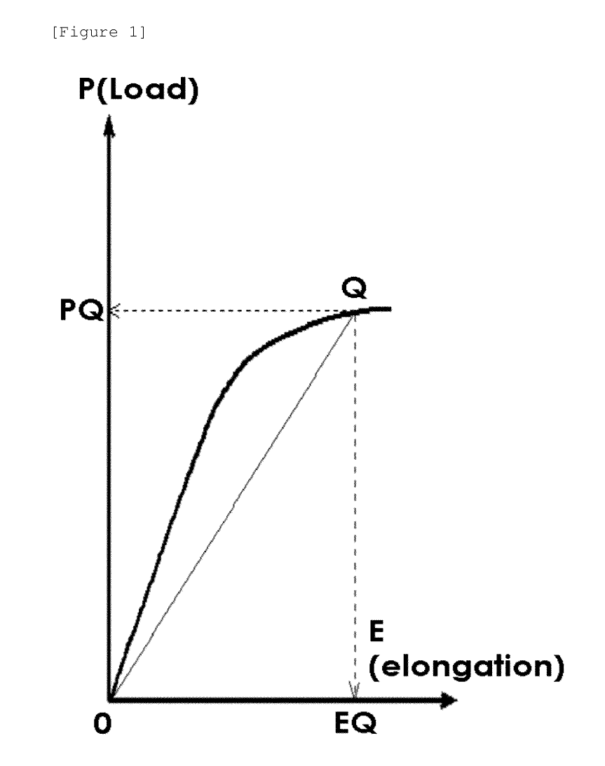

Mechanical property (a): The copper foil according to the present invention has the mechanical property described below, and can be suitably used as a current collector for a negative electrode of a lithium ion secondary battery. First, the mechanical property (a) of the copper foil is that in the strain-stress curve (see FIG. 1) obtained in the tensile test in which a 10 mm wide test specimen composed of the copper foil is used, a maximum strain loaded on the copper foil is 30 N or higher in a region where “Value L” represented by the following expression (1) is 0.8 or more wherein the starting point of the curve is taken as O, and a point on the curve where the load at an elongation of E_{Q} is P_{Q} is taken as Q. Hereinafter, a maximum strain load in the region of “Value L” of 0.8 or more when the test specimen is subjected to the tensile test is referred to as “Value S” in the present application.

$$\begin{matrix}[ Expression 2 ] & \\ Value L = \frac{( area of triangle {OQE}_{Q} )}{( area of region {OQE}_{Q} )} & ( 1 )\end{matrix}$$

Here, in the expression (1), the triangle OQE_{Q} indicates a triangle having corners at the starting point O, the point Q and the point E_{Q} in the stress-strain curve. The region OQE_{Q} indicates a region surrounded by a curve OQ in the stress-strain curve, a line QE_{Q} and a line OE_{Q} in the stress-strain curve.

Tensile test: Here, the tensile test in the present invention is carried out as follows. In the present invention, the shape of a test specimen is made to be a 10 mm wide nearly rectangular shape. The gauge length is 50 mm, and the crosshead speed is 5 ram/min. Here, as an index indicating the mechanical strength of a copper foil, the tensile strength is usually employed. A tensile strength is represented by a stress (N/mm²) corresponding to a maximum strain load in the test. These results in a value are acquired by dividing a strain on a test specimen by a cross-section area of the test specimen. The tensile strength is a basic mechanical property of materials. Therefore, if copper foils are of the same kind, even if the copper foils have different thicknesses, the tensile strengths of the copper foils show almost same value. However, even when copper foils of the same kind are used as current collectors, when the same strain (N) is loaded, actual amount of deformation of a current collector decreases in a thicker copper foil. Then, method of representing the mechanical properties as a copper foil for a current collector has been found in which not a tensile strength measured by a tensile test, but a value of a strain (N) actually loaded on a test specimen is used in the present invention. By employing the present method, the mechanical properties of a copper foil is more suitably specified and a suitable copper foil as a negative electrode current collector of lithium ion secondary battery employing Si, Sn or the like as a negative electrode active substance can be selected.

“Value L” determined according to above expression (1) based on a stress-strain curve when a copper foil is subjected to a tensile test as described above is an index representing the linearity of the stress-strain curve. When the areas of the triangle OQE_{Q} and the region OQE_{Q} are equal in the stress-strain curve, “Value L” is “1”, i.e. a highest linearity in a stress-strain curve. The case where “Value L” is 0.8 or more in the range of a strain loaded on the test specimen of 30 N or less means a high linearity in a stress-strain curve. Therefore, if the load is 30 N or less, a copper foil having such “Value L” can recover its nearly original dimensional shape when the strain loaded is released even if being strained by the load. Therefore, by using the copper foil according to the present invention as a current collector, a possibility of causing deformation such as wrinkles in the current collector decreases even if the charge/discharge operation is repeated. Even if deformation such as wrinkles generates on a current collector, the amount of deformation might be extremely small and a level may not affect on practical use.

In contrast, in the case of a copper foil showing “Value L” of smaller than 0.8 in the range of the strain loaded on a test specimen of 30 N or less, the copper foil follows the expansion of volume of a negative electrode mixture layer in the charge operation, and thereafter, when volume of the negative electrode mixture layer contracts in the discharge operation, the copper foil cannot recover original shape and wrinkles and the like generates in a current collector in some cases. If deformation of the copper foil as a current collector is large, a negative electrode mixture layer may peels off; or short circuit may occur between a positive electrode and a negative electrode; and the distance between the positive electrode and the negative electrode may change to inhibit a uniform electrode reaction. Therefore, in repeating of the charge/discharge operation, the electric performance of a lithium ion secondary battery decreases, and the life of the lithium ion secondary battery may be shortened.

Mechanical property (b): Here, the copper foil according to the present invention preferably shows “Value L” of 0.8 or more in the range of the strain loaded on the test specimen of 30 N or less. “Value L” is more preferably 0.8 or more in the range of the strain loaded on the test specimen of 40 N or less. When “Value L” is 0.8 or more in the range of the strain loaded on the test specimen of 30 N or less, possibility of causing deformation such as wrinkles in a current collector in the repeated charge/discharge operation as described above decreases. When “Value L” is 0.8 or more in the range of the strain loaded on the test specimen of 40 N or less, possibility of causing deformation such as wrinkles on a current collector in the repeated charge/discharge operation may further decreases. Particularly, when a material such as tin or silicon showing a large volume change in the charge operation is used as a negative electrode active substance, using of a copper foil which shows “Value L” of 0.8 or more in the range of the strain loaded on the test specimen of 40 N or less is more preferable.
Mechanical property (c): The copper foil according to the present invention preferably has an elongation (%) of 0.1 to 3.5 when a strain of 30 N is loaded on the test specimen. If the elongation (%) of a test specimen is smaller than 0.1 when a strain of 30 N is loaded on the test specimen, and when the copper foil is employed as a current collector, the current collector cannot follow volume expansion of a negative electrode mixture layer; and risk of fracture in the current collector may arise in the charge/discharge operation. In contrast, if the elongation (%) exceeds 3.5 when a strain of 30 N is loaded, and when the copper foil is employed as a current collector, the current collector follows volume expansion of a negative electrode mixture layer to expand; consequently a risk of causing wrinkles on the current collector may arise. Elongation (%) is preferably 0.1 to 3.5 from these viewpoints.
Mechanical properties after heat treatment: In the copper foil for a negative electrode current collector of a lithium ion secondary battery according to the present invention, the test specimen after heat treatment at 70° C. to 450° C. preferably has above-mentioned mechanical properties also. As already described, in a manufacturing step of a negative electrode material, a negative electrode mixture is applied on a current collector, and then may be heat treated for such as drying and/or annealing. Therefore, if the copper foil has above-mentioned mechanical properties after heat treatment at 70° C. to 450° C. also, deformation of a current collector in the charge/discharge operation can be prevented irrespective of the presence/absence of the thermal influence in the manufacturing step of the negative electrode material. Specifically, in the manufacturing step of the negative electrode material, a negative electrode mixture is applied, followed by drying in the temperature range of about 70° C. to 200° C. for several seconds to several tens of minutes to remove the solvent. When a polyamic acid (polyimide precursor) is used as a binder, a negative electrode mixture is applied on a surface of a current collector, followed by a dehydrating condensation reaction of the polyamic acid to finish a polyimide resin. At this time, heat treatment is carried out in the temperature range of 120° C. to 450° C. for about 0.5 hour to 5 hours. Therefore, also after heat treatment carried out in such a temperature range for about 0.5 hour to 5 hours, the copper foil is preferable to have above-mentioned mechanical properties. Here, the properties described above refer to at least the mechanical property (a) among the mechanical properties (a) to (c). That is, “Value S” is 30 N or more in the region of “Value L” of 0.8 or more in a stress-strain curve when a copper foil after heat treatment at 70° C. to 450° C. is used as the test specimen and subjected to a tensile test.
Thickness: Here, thicker the thickness of the copper foil used as a current collector, smaller the elongation (amount of deformation) of the current collector when the same strain (N) is loaded on the copper foils of the same kind. Therefore, a thick copper foil is preferably employed from the viewpoint to prevent deformation in the current collector. However, thin current collector is more preferable from the viewpoint to further miniaturize a lithium ion secondary battery. This is because if thickness of a current collector increases, the capacity per unit volume of a lithium ion secondary battery decreases, so it is not preferable. From these viewpoints, preferable thickness of the copper foil for a negative electrode current collector of a lithium ion secondary battery according to the present invention is 35 μm or less, more preferably 18 μm or less, and still more preferably 12 μm or less. In contrast, in consideration of the production efficiency in manufacturing of a negative electrode material, it is preferable that the copper foil has a suitable handleability, and the copper foil has thickness of 6 μm or more. However, the lower limit of thickness is not especially limited as long as the copper foil according to the present invention satisfies above-mentioned mechanical properties.
Surface roughness (Ra): The surface roughness (Ra) of surfaces of the copper foil for a negative electrode current collector of a lithium ion secondary battery according to the present invention is preferably 0.1 μm or more, respectively. Furthermore, the surface roughness (Ra) of each surface is more preferably in the range of 0.2 μm to 0.7 μm. The surface roughness (Ra) of each surface of 0.2 μm to 0.7 μm secures tight contact with a negative electrode mixture layer. Here, the difference in surface roughness (Ra) between surfaces of a copper foil is preferably 0.6 μm or less. This is because if a difference in surface roughness (Ra) between one surface and the other surface is big, a stress difference between the surfaces generates and the wrinkles may occur.
Electro-deposited copper foil: The copper foil for a negative electrode current collector of a lithium ion secondary battery according to the present invention may be a rolled copper foil or an electro-deposited copper foil. However, in consideration of the economical performance and the production efficiency, an electro-deposited copper foil is preferably used from the viewpoint of inexpensive manufacturing cost.

One example of an electro-deposited copper foil having above-mentioned mechanical properties and the like includes one having a chlorine content of 40 ppm to 200 ppm. The electro-deposited copper foil can be manufactured by an electrolysis using an electrolytic solution having, for example, a copper concentration of 60 g/L to 90 g/L, a sulfuric acid concentration of 80 g/L to 250 g/L, chlorine ion concentration of 1 ppm to 3 ppm, and a gelatin-based additive concentration of 0.3 ppm to 5 ppm; temperature of the electrolytic solution at 40° C. to 60° C.; and an electrolytic current density of 30 A/dm² to 120 A/dm².

When an electro-deposited copper foil is used, one surface or both surfaces are preferably subjected to a roughening treatment according to needs to make the surface roughness (Ra) of each surface to be in above-mentioned range. An electro-deposited copper foil having a certain smoothness of each surface has more uniform foil thickness, and by making the surface roughness (Ra) of each surface to be in above-mentioned range, the tight contact between a negative electrode mixture layer and a current collector can be secured. Further, a smaller difference in surface roughness (Ra) between both surfaces can prevent deformation caused by the stress difference as described above, so it is preferable.

Silane coupling agent treatment: The copper foil for a negative electrode current collector of a lithium ion secondary battery according to the present invention is preferably provided with a silane coupling agent layer on at least the surface of the copper foil to where a negative electrode mixture layer is provided. This is because a silane coupling agent layer improves tight contact between the copper foil and the negative electrode mixture layer.

Here, the silane coupling agents include an epoxyalkoxysilane, an aminoalkoxysilane, a methacryloxyalkoxysilane and a mercaptoalkoxysilane. Such a silane coupling agent may be used as a mixture of two or more. A silane coupling agent layer can be formed by a well-known method. Specifically, a silane coupling agent is applied on the surface of the copper foil by an immersion or spray treatment or the like followed by drying, and then heat treated or the like according to need to finish a silane coupling agent layer on the surface of the copper foil.

When the copper foil having above-mentioned features is used as a current collector constituting a negative electrode material of a lithium ion secondary battery, even if volume of a negative electrode mixture layer expand in the charge operation, the current collector can follow thereto. Then, when volume of the negative electrode mixture layer contracts in the discharge operation, since the current collector can recover its nearly original shape, the generation of deformation such as wrinkles in the current collector can be prevented even if the charge/discharge operation is repeated.

The present embodiment described above is only one aspect of the present invention, and suitable changes and modifications may be made without departure from the gist of the present invention. Then, the present invention will be described more specifically by demonstrating Examples, but the present invention is not limited to the following Examples.

### Example 1

### Preparation of a Negative Electrode Current Collector of a Lithium Ion Secondary Battery

Electro-deposited copper foil preparation step: In Example 1, electro-deposited copper foil 1 was prepared as a copper foil for a negative electrode current collector of a lithium ion secondary battery as follows. In the preparation of the electro-deposited copper foil 1, a well-known electro-deposited copper foil manufacturing apparatus equipped with a rotating cathode was used. Electrolysis was carried out at a solution temperature of 50° C. and at a current density of 60 A/dm² by using continuously fed an electrolytic solution containing 80 g/L of copper ions, 250 g/L of sulfuric acid, 2.7 ppm of chlorine ions and 2 ppm of gelatin to deposit copper on a surface of the rotating cathode. The copper foil electro-deposited on the surface of the rotating cathode was peeled off to prepare an electro-deposited copper foil 1 of 12 μm in thickness estimated form mass (gauge thickness: 12 μm). Here, the thickness estimated form mass refers to thickness determined from a density of copper based on a mass per unit area.

Roughening treatment step: Then, a roughening treatment was carried out using a popular roughening treatment apparatus. In the roughening treatment, a sulfuric acid-base copper electrolytic solution containing 8 g/L of copper ions and 200 g/L of sulfuric acid was used as an electrolytic solution, and employed a burning plating condition of a solution temperature of 35° C. and a current density of 25 A/dm² to deposit and form copper particles. Thereafter, a seal plating was carried out to prevent the falling-off of the deposited and formed copper particles by using a sulfuric acid-base copper electrolytic solution containing 70 g/L of copper ions and 110 g/L of sulfuric acid and employing a level plating condition of a solution temperature of 50° C. and a current density of 25 A/dm² to finish the roughening treatment. The surface roughness (Ra) of one surface having a larger roughness of the electro-deposited copper foil 1 prepared in this step was 0.35 μm, and the surface roughness (Ra) of the other surface was 0.32 μm. In the Example 1, surface roughness (Ra) was measured by using a stylus based surface roughness measurement instrument (trade name: SE-3500) made by Kosaka Laboratory Ltd. Hereinafter, all the measurement of the surface roughness (Ra) was carried out by the same method.
Silane coupling agent treatment step: The electro-deposited copper foil 1 after the roughening treatment step was subjected to a silane coupling agent treatment. In the Example 1, 3-aminopropyltrimethoxysilane was used as a silane coupling agent. A spray treatment using a shower was carried out to form a silane coupling agent layer on both surfaces of the electro-deposited copper foil 1.

### <Preparation of a Negative Electrode Material>

On a surface of the electro-deposited copper foil 1 prepared as described above, a negative electrode mixture layer was provided as follows. First, a negative electrode mixture containing a negative electrode active substance, a conductive material and a binder was prepared in order to provide a negative electrode mixture layer. In the Example 1, silicon powder as the negative electrode active substance; an acetylene black as the conductive material; a polyamic acid as the binder; and NMP (N-methylpyrrolidone) as a solvent were used. These were mixed in a mixing ratio (mass ratio) of 100:5:15:184, respectively, to prepare a negative electrode mixture (slurry). The negative electrode mixture was coated on one surface (here, a surface having a larger roughness) of the electro-deposited copper foil 1 by using an applicator, and dried at 200° C. for 2 hours to evaporate the solvent, followed by an anneal treatment at 350° C. for 1 hour for a dehydrating condensation reaction of the polyamic acid.

The specimen having a negative electrode size of 31 mm wide and 41 mm long was cut out from electro-deposited copper foil 1 provided with the negative electrode mixture layer on one surface. Here, a tab composed of a Ni foil was attached to one side of an edge portion of the electrode surface in the longitudinal direction. The finished specimen was named a negative electrode material 1-1.

Next, the negative electrode mixture layer was provided on both surfaces of the electro-deposited copper foil 1 by the same procedure as in above, and the resultant was cut into the same size as in the negative electrode material 1-1; and a tab composed of a Ni foil was attached to the same position as in the negative electrode material 1-1 to finish a negative electrode material 1-2.

### Example 2

In Example 2, except that the electro-deposited copper foil 2 of 15 μm in thickness estimated form mass (gauge thickness: 15 μm) was prepared in the electro-deposited copper foil preparation step, a negative electrode material 2-1 provided with the negative electrode mixture layer on only one surface of an electro-deposited copper foil 2, and a negative electrode material 2-2 provided with the negative electrode mixture layer on both surfaces of an electro-deposited copper foil 2 were prepared as same in Example 1. Here, the surface roughness (Ra) of one surface having a larger roughness of the electro-deposited copper foil 2 prepared in the Example 2 was 0.36 μm, and the surface roughness (Ra) of the other surface was 0.32 μm.

### Example 3

In Example 3, except that the electro-deposited copper foil 3 of 17 μm in thickness estimated form mass (gauge thickness: 18 μm) was prepared in the electro-deposited copper foil preparation step, a negative electrode material 3-1 provided with the negative electrode mixture layer on only one surface of an electro-deposited copper foil 2, and a negative electrode material 3-2 provided with the negative electrode mixture layer on both surfaces of an electro-deposited copper foil 3 were prepared as same in Example 1. Here, the surface roughness (Ra) of one surface having a larger roughness of the electro-deposited copper foil 3 prepared in the Example 3 was 0.37 μm, and the surface roughness (Ra) of the other surface was 0.31 μm.

### Comparative Example

In Comparative Example, a both surface smooth copper foil of 15 μm in thickness estimated form mass was used as a comparative electro-deposited copper foil to compare with Examples 1 to 3 above. Specifically, except that DFF 15 (gauge thickness: 15 μm) of a DFF (Registered trade mark) series commercially available from Mitsui Mining & Smelting Co., Ltd. was used, a comparative negative electrode material 1-1 provided with the negative electrode mixture layer on only one surface of a comparative electro-deposited copper foil, and a comparative negative electrode material 1-2 provided with the negative electrode mixture layer on both surfaces of a comparative electro-deposited copper foil were prepared as same in Example 1. Here, the surface roughness (Ra) of one surface having a larger roughness of the comparative electro-deposited copper foil used in Comparative Example was 0.19 μm, and the surface roughness (Ra) of the other surface was 0.16 μm.

### 1. Preparation of Evaluation Cells

In order to carry out deformation evaluation in the charge/discharge operation of the electro-deposited copper foils 1 to 3 used as the current collector in Examples 1 to 3 and the comparative electro-deposited copper foil, and the cycle durability evaluation in the charge/discharge operation as lithium ion secondary batteries, deformation-evaluation cells and cycle durability-evaluation cells were prepared as follows, respectively.

### 1-1 Preparation of Deformation-Evaluation Cells

In order to carry out deformation evaluation of each electro-deposited copper foil after the charge/discharge operation by half-cell evaluation, a two-layer laminate cell for deformation evaluation and a three-layer laminate cell for deformation evaluation were prepared as deformation-evaluation cells respectively. In each deformation-evaluation cell, the negative electrode materials 1-1 to 3-2 and the comparative negative electrode materials 1-1 and 1-2 were used as respective test electrodes. Then, a lithium metal electrode was used as a counter electrode for each test electrode.

### <Preparation of a Counter Electrode Material>

The lithium metal electrode as the counter electrode for the test electrode was prepared as follows. As a current collector, the electro-deposited copper foil 1 used for the negative electrode material 1-1 cut out into the same size was used. A counter electrode material for deformation evaluation was prepared by covering the surface of this electro-deposited copper foil 1 with a lithium metal foil.

### <Preparation of Two-Layer Laminate Cells for Deformation Evaluation>

First, each of both surfaces of the negative electrode material 1-1 provided with the negative electrode mixture layer on only one surface was covered with a separator; and the counter electrode material was arranged to make the lithium metal foil face to the negative electrode mixture layer through the separator. Then a pair of electrodes was finished. Next, the pair of electrodes was covered with a laminate material; and an edge of the laminate material without an injection port of an electrolytic solution was heat sealed. At this time, the tab was exposed outside from the laminate material. Then, an electrolytic solution was injected from the injection port inside the laminate material in a glove box, and the injection port was then heat sealed to prepare a lithium ion secondary battery having a two-layer laminate structure. Thus, a deformation-evaluation cell 1-1 using the electro-deposited copper foil prepared in Example 1 as the current collector was prepared. Then, a deformation-evaluation cell 2-1 was prepared as in above, except that the negative electrode material 2-1 prepared in Example 2 was used in place of the negative electrode material 1-1 and the electro-deposited copper foil 2 was used as a current collector for the counter electrode. Also, a deformation-evaluation cell 3-1 was prepared as in above, except that the negative electrode material 3-1 prepared in Example 3 and the electro-deposited copper foil 3 as a current collector for the counter electrode were used. Further a deformation-comparative cell 1-1 was prepared as in above, except that the comparative negative electrode material 1-1 prepared in Comparative Example and the comparative electro-deposited copper foil as a current collector for the counter electrode were used.

### <Preparation of Three-Layer Laminate Cells for Deformation Evaluation>

Next, each of both surfaces of the negative electrode material 1-2 provided with the negative electrode mixture layer on both surfaces was covered with a separator; and the counter electrode material was arranged on each of both surfaces to make the negative electrode mixture layer and the lithium metal foil face through the separator. Then, a lithium ion secondary battery having a three-layer laminate structure was prepared as in deformation-evaluation cell 1-1, except that the pair of electrodes was used. Thus, a deformation-evaluation cell 1-2 using the electro-deposited copper foil prepared in Example 1 as the current collector was prepared. Then, a deformation-evaluation cell 2-2 was prepared as in above, except that the negative electrode material 2-2 prepared in Example 2 was used in place of the negative electrode material 1-2 and the electro-deposited copper foil 2 was used as a current collector for the counter electrode. Also, a deformation-evaluation cell 3-2 was prepared as in above, except that the negative electrode material 3-2 prepared in Example 3 and the electro-deposited copper foil 3 as a current collector for the counter electrode were used. Further a deformation-comparative cell 1-2 was prepared as in above, except that the comparative negative electrode material 1-2 prepared in Comparative Example and the comparative electro-deposited copper foil as a current collector for the counter electrode were used.

### 1-2 Preparation of the Cycle Durability-Evaluation Cells

In order to carry out the cycle durability of the lithium ion secondary batteries using the respective electro-deposited copper foils as the negative electrode current collector by full-cell evaluation, three-layer laminate cells for durability evaluation using the negative electrode materials 1-2 and 3-2 and the comparative negative electrode material 1-2 were prepared as follows respectively as cycle durability-evaluation cells. Here, the cycle durability refers to the evaluation determined by a capacity maintenance rate (%) of a lithium ion secondary battery when the charge/discharge operation is repeated.

### <Preparation of a Positive Electrode Material>

First, a positive electrode material used as a positive electrode to pair with each negative electrode was prepared as follows. Lithium manganate as a positive electrode active substance, an acetylene black as a conductive material, a polyvinylidene fluoride as a binder and NMP as a solvent were used, and mixed in a mixing ratio (mass ratio) of 5.6:6.8:100:102 respectively, to prepare a positive electrode mixture (slurry). The positive electrode mixture was coated on a current collector composed of an aluminum foil by using an applicator followed by drying, and thereafter subjected to rolling and pressing to prepare a positive electrode material. The positive electrode material thus prepared was cut out to make the size of the electrode surface of 29 mm wide and 40 mm long. Here, a tab composed of an Al foil was attached to one side of an edge portion of the electrode surface in the longitudinal direction. Thus a positive electrode material was finished.

### <Preparation of Three-Layer Laminate Cells for Durability Evaluation>

A cycle durability-evaluation cell 1 was prepared by the same preparation method of the three-layer laminate cells for deformation evaluation by using the negative electrode material 1-2 as a negative electrode and the positive electrode material as a positive electrode. Also, a cycle durability-evaluation cell 3 was prepared by using the negative electrode material 3-2 as a negative electrode and the positive electrode material as a positive electrode. Further, a cycle durability-evaluation cell was prepared by using the comparative negative electrode material 1-2 as a negative electrode and the positive electrode material as a positive electrode.

### 2. Charge/Discharge Operation

### 2-1 Charge/Discharge Operation on Deformation-Evaluation Cells

On deformation-evaluation cells 1-1 to 3-2 and deformation-comparative cells 1-1 and 1-2 prepared as above, one cycle of the charge/discharge operation was carried out. Charge operation was carried out under the capacity control, and discharge operation was carried out under the voltage control. Specifically, charge operation in the first cycle was carried out as follows. First, charge operation was carried out under a constant current (CC) mode at a charge rate of 0.05 C until a final voltage reaches 0.001 V (vs. Li/Li+). Thereafter successively, charge operation was carried out under a constant voltage (CV) mode until the current value reached 0.01 C. Further charge operation was carried out at a charge rate of 0.05 C until the capacity reached 82.5% against a discharge capacity of 100% which is performed when discharge operation was carried out under a constant current (CC) mode at a discharge rate of 0.05 C until the final voltage reaches 1.5 V. In contrast, discharge operation was carried out at a discharge rate of 0.05 C until the final voltage reached 1.5 V.

### 2-2 Charge/Discharge Operation on Cycle Durability-Evaluation Cells

On the cycle durability-evaluation cells 1 and 3 and the cycle durability-evaluation cell prepared above, 50 cycles of the charge/discharge operations were carried out in order to evaluate the capacity maintenance rates (%). Charge operation and the discharge operation were carried out under the voltage control. 50 cycles of charge/discharge operations were carried out on each cell. Specifically, charge operation of the first cycle was carried out under a constant current and constant voltage (CCCV) mode at a charge rate of 0.05 C until a final voltage reaches 4.2 V. Discharge operation of the first cycle was carried out under a constant current (CC) mode at a discharge rate of 0.05 C until a final voltage reaches 3.0 V. Then, charge operation of the second cycle to the fifth cycle was carried out under a constant current and constant voltage (CCCV) mode at a charge rate of 0.1 C until a final voltage reaches 4.2 V. In contrast, discharge operation was carried out under a constant current (CC) mode at a discharge rate of 0.1 C until a final voltage reaches 3.0 V. Charge/discharge operation from the sixth cycle to the 50th cycle was carried out under the same mode except that a charge rate of 0.5 C and a discharge rate of 0.5 C were employed.

### 3. Evaluation Methods

On the copper foils prepared in the Examples 1 to 3 and the copper foil used in Comparative Example, evaluations were carried out on the item 3-1; physical property (mechanical properties), the item 3-2; deformation after the charge/discharge operation and the item 3-3; performance as the negative electrode current collector of the lithium ion secondary battery. Each evaluation method was as follows.

### 3-1 An Evaluation Method of the Physical Property (Mechanical Properties)

First, physical properties as received and after heat treatment were evaluated on the electro-deposited copper foils 1 to 3 and the comparative electro-deposited copper foil used as the negative electrode current collector of the lithium ion secondary battery in Examples 1 to 3 and Comparative Example. For the evaluations of the physical properties, each electro-deposited copper foil was used as a test specimen and subjected to a tensile test using a universal tester (type: 5582) made by Instron Corp. The shape of the test specimen was finished to have a rectangular shape of 10 mm wide, and the gauge distance was set 50 mm. The crosshead speed was 5 mm/min. In the tensile test, a maximum load (N), a tensile strength (N/mm²), an elongation at break (%) and “Value S” were determined for each test specimen. Note that, the maximum load refers to a maximum strain load (N) on a test specimen during the test. The tensile strength refers to a value (N/mm²) acquired by dividing a maximum strain load by a cross-section area of a test specimen. The elongation at break (%) refers to a value (%) in the percentage of a permanent elongation after break to an original gauge distance (50 mm). “Value S” is as described above, and refers to a value of the maximum strain loaded on the test specimen in the tensile test in a range “Value L” of 0.8 or more. The electro-deposited copper foil as received particularly refers to an electro-deposited copper foil without heat treatment. In contrast, the electro-deposited copper foil after heat treatment in the present evaluation refers to an electro-deposited copper foil after heated and dried at 200° C. for 2 hours and then anneal treated at 350° C. for 1 hour.

3-2 A Method for Evaluating Deformation after the Charge/Discharge Operation

Deformation evaluation after the charge/discharge operation was carried out as follows. On deformation-evaluation cells 1-1 to 3-2, and deformation-comparative cells 1-1 and 1-2, one cycle of the charge/discharge operation was carried out by above-mentioned method, and then an X-ray-CT image along cross-section of each cell was obtained and investigated. Based on the X-ray-CT image along cross-section of each cell, deformation ratios (elongations) of the electro-deposited copper foils 1 to 3 and the comparative electro-deposited copper foil used as the current collectors were determined. Further, each cell was disassembled, and whether deformation such as wrinkles was generated or not on the electro-deposited copper foils 1 to 3 and the comparative electro-deposited copper foil was visually investigated. Note that, an industrial X-ray CT scanner (TOSCANER-32250 μhd) made by Toshiba IT & Control Systems Corporation was used for imaging of the X-ray-CT.

### 3-3 Evaluation as the Negative Electrode Current Collectors of the Lithium Ion Secondary Batteries

The electro-deposited copper foils 1 to 3 and the comparative electro-deposited copper foil as the negative electrode current collectors of the lithium ion secondary batteries were evaluated. Specifically, based on deformation ratio (%) and the wrinkle generation in each electro-deposited copper foil after one cycle of the charge/discharge operation, “Value L” when a strain of 30 N was loaded on a test specimen of each electro-deposited copper foil after heat treatment in the tensile test, the capacity maintenance rate (%) of the lithium ion secondary battery after 50 cycles of the charge/discharge operation, and “Value S” of each electro-deposited copper foil after heat treatment, whether each electro-deposited copper foil is suitable or not as the negative electrode current collector of the lithium ion secondary battery was determined.

Here, deformation ratio (%) of an electro-deposited copper foil is a percentage of an amount of expansion of a current collector in specific direction (for example, in the longitudinal direction) after one cycle of the charge/discharge operation by above-mentioned method to an original size of the current collector in the specific direction, in each deformation-evaluation cell. The capacity maintenance rate (%) was determined as a capacity maintenance rate (%) of each cell after 50 cycles of the charge/discharge operation by calculating (discharge capacity at the 50th cycle)/(discharge capacity at the 5th cycle)×100. For the wrinkle generation, “Value L” and “Value S”, the same with the item 3-1, an evaluation method of the physical property (mechanical properties), same with the item 3-2, a method for evaluating deformation after the charge/discharge operation were employed.

### 4. Evaluation Results

Hereinafter, each evaluation result will be described.

### 4-1 Physical Properties

Table 1 shows physical properties as received and after heat treatment of the electro-deposited copper foils 1 to 3 used as the current collectors in Examples 1 to 3 together with physical properties of the comparative electro-deposited copper foil used as the current collector in Comparative Example.

TABLE 1

| | | | | | | Comparative |
|---|---|---|---|---|---|---|
| | | | | | | Electro- |
| | | | Electro- | Electro- | Electro- | Deposited |
| | | | Deposited | Deposited | Deposited | Copper Foil |
| | | | Copper Foil 1 | Copper Foil 2 | Copper Foil 3 | (Comparative |
| | | | (Example 1) | (Example 2) | (Example 3) | Example) |
| Copper Foil Thickness (Thickness | | (μm) | 12 | 15 | 17 | 15 |
| estimated form mass) | | | | | | |
| As Received | Maximum Strain Load | (N) | 66 | 80 | 87 | 51 |
| | Tensile Strength | (N/mm²) | 545 | 552 | 547 | 352 |
| | Elongation at Break | (%) | 8 | 8 | 8 | 15 |
| After Heat | “Value S” | (N) | 32 | 35 | 40 | 19 |
| Treatment | Maximum Strain Load | (N) | 40 | 46 | 54 | 35 |
| | Tensile Strength | (N/mm²) | 331 | 317 | 340 | 241 |
| | Elongation at Break | (%) | 14 | 15 | 14 | 19 |

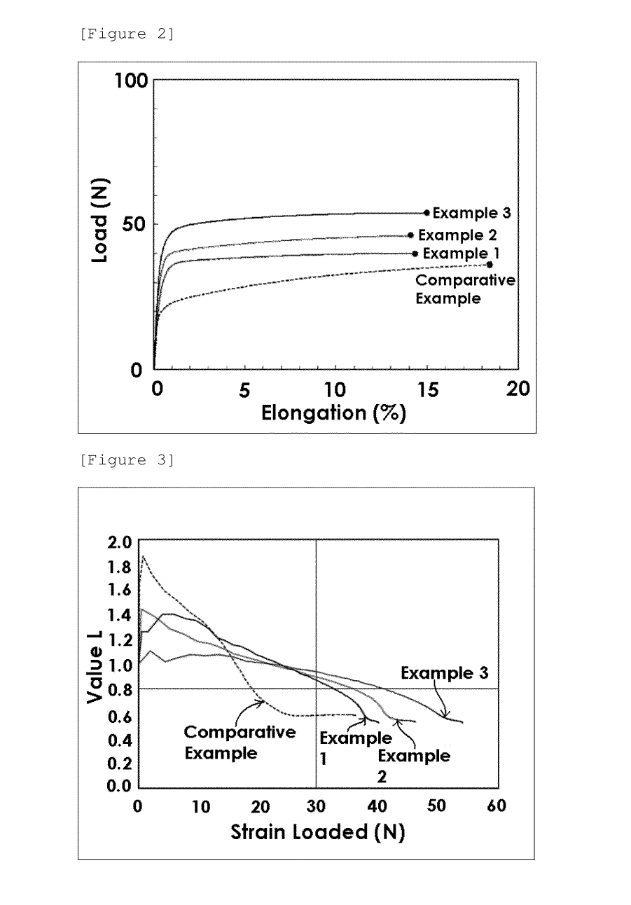

As shown in Table 1, all of “Value S” after heat treatment of the electro-deposited copper foils 1 to 3 prepared in Examples 1 to 3 shows 30 N or more. In contrast, “Value S” of the comparative electro-deposited copper foil used in Comparative Example shows 19 N. According to Table 1, heat treatment decreases the mechanical strength of each electro-deposited copper foil than as received. Next, FIG. 2 shows a stress-strain curve of each test specimen obtained in the tensile test on each electro-deposited copper foil after heat treatment. Further, FIG. 3 shows plots of “Value L” determined based on above expression (1) to a strain load in the stress-strain curve obtained in the tensile test on each electro-deposited copper foil after heat treatment, where the starting point of the curve is taken as O, and a point on the curve where the load at an elongation of E_{Q} is P_{Q} is taken as Q (see FIG. 1). As shown in FIG. 2 and Table 1, the electro-deposited copper foils 1 to 3 prepared in Examples 1 to 3 have higher maximum strain loads than the electro-deposited copper foil used as the current collector in Comparative Example. As shown in FIG. 3, in each electro-deposited copper foil used as the current collector in Examples 1 to 3, “Value L” is 0.8 or more in a range of the strain loaded on a test specimen composed of each electro-deposited copper foil of 30 N or less.

4-2 Deformation Evaluation after the Charge/Discharge Operation

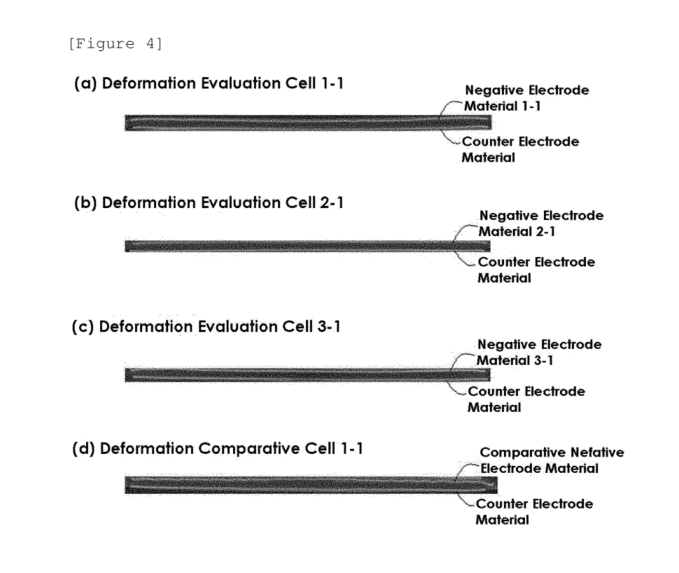

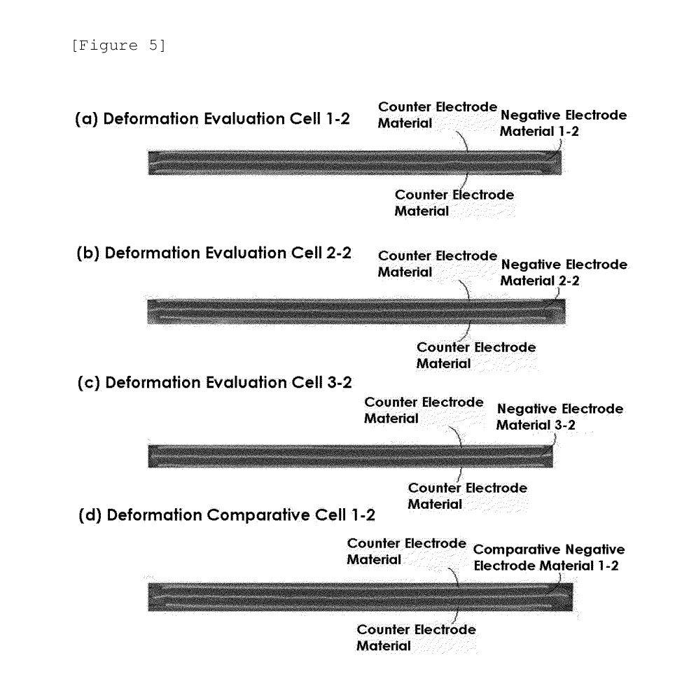

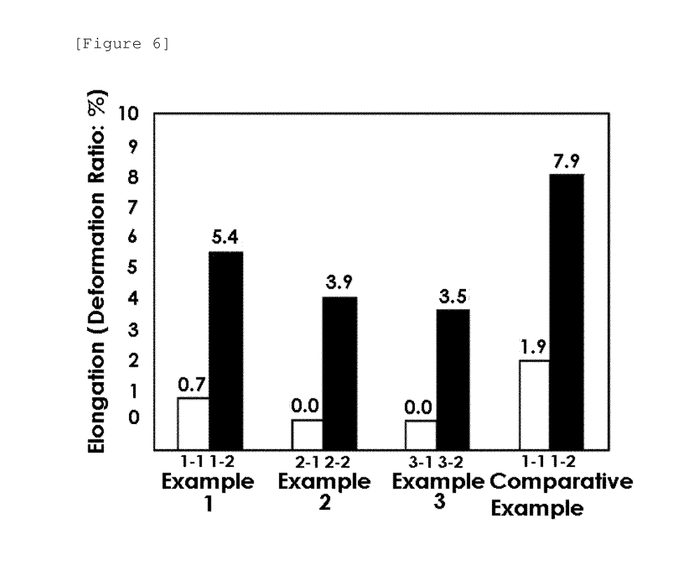

X-ray-CT images obtained by photographing a cross-section of each deformation-evaluation cell after one cycle of the charge/discharge operation are shown in FIGS. 4 and 5. Here, FIG. 4 shows a cross-section of each cell of the two-layer laminate cell type: (a) is a cross-section of deformation-evaluation cell 1-1; (b) is a cross-section of deformation-evaluation cell 2-1; (c) is a cross-section of deformation-evaluation cell 3-1; and (d) is a cross-section of deformation-comparative cell 1-1. Next, FIG. 5 shows a cross-section of each cell of the three-layer laminate cell type: (a) is a cross-section of deformation-evaluation cell 1-2; (b) is a cross-section of deformation-evaluation cell 2-2; (c) is a cross-section of deformation-evaluation cell 3-2; and (d) is a cross-section of deformation-comparative cell 1-2.

According to these X-ray-CT images, the matter is apparent that the three-layer laminate cells shown in FIG. 5 have larger amounts of expansion (amounts of deformation) in the electro-deposited copper foils used as the negative electrode current collectors than the two-layer laminate cells shown in FIG. 4. As shown in FIG. 4(d) and FIG. 5(d), expansion is large in the comparative electro-deposited copper foil, and depending on a rippling state in cross-sectional view, wrinkles might generate. In contrast, as shown in FIGS. 4(a) to 4(c) and FIG. 5(a) to FIG. 5(c), it is visually recognized that expansions are smaller and generation of wrinkles are less in the electro-deposited copper foils 1 to 3 than the comparative electro-deposited copper foil.

Next, FIG. 6 shows a deformation ratio (%) of each current collector after one cycle of the charge/discharge operation of deformation-evaluation cells 1-1 to 3-2 and deformation-comparative cells 1-1 and 1-2. According to FIG. 6, the matter is apparent that deformation ratio after one cycle of the charge/discharge operation is very high in the comparative electro-deposited copper foil used as the current collector in Comparative Example. Further, the matter in the electro-deposited copper foils 1 to 3 used in Examples 1, 2 and 3 is also apparent that deformation ratio decreases as thickness (of the copper foil) increases whether the negative electrode mixture layer is provided on one surface (negative electrode materials 1-1, 2-1 and 3-1) or the negative electrode mixture layer is provided on both surfaces (negative electrode materials 1-2, 2-2 and 3-2).

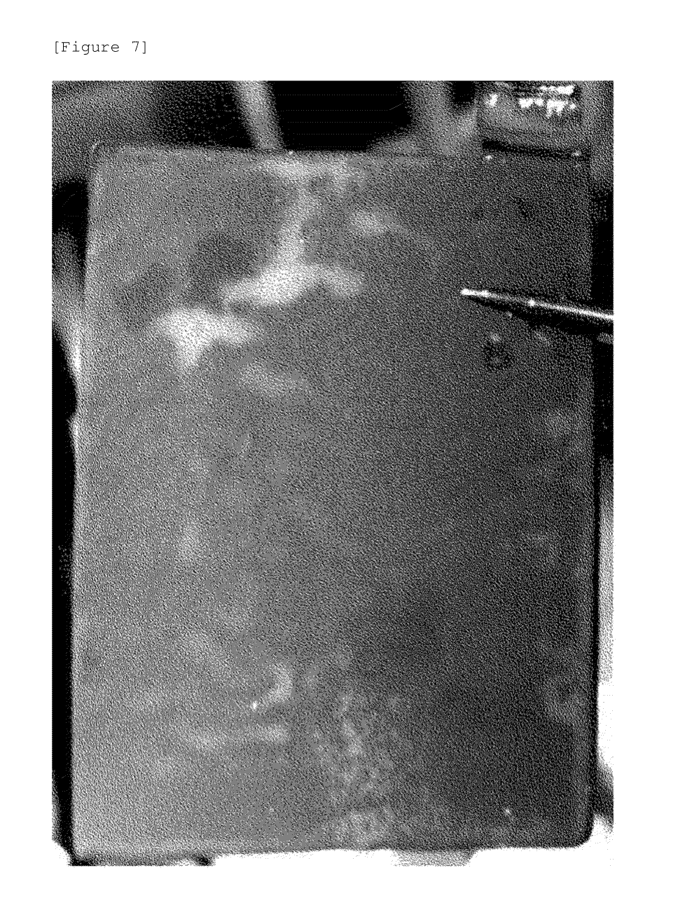

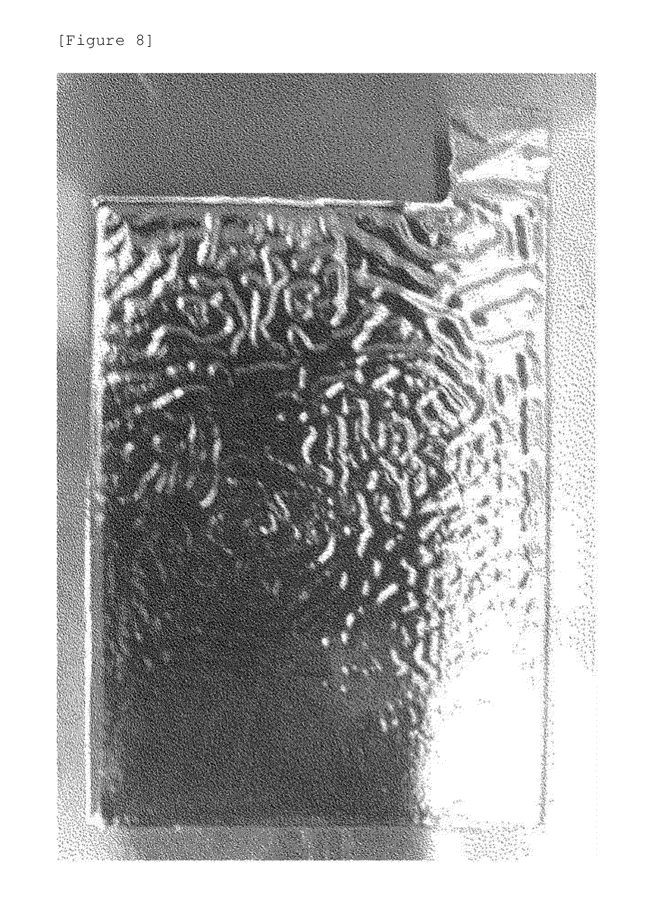

FIGS. 7 and 8 show photographed images of the current collectors prepared by disassembling deformation-evaluation cell 3-2 and deformation-comparative cell 1-1 after one cycle of the charge/discharge operation, respectively. According to FIG. 7, the matter is apparent that the electro-deposited copper foil 3 used as the negative electrode current collector in deformation-evaluation cell 3-2 is wrinkle free even when the negative electrode mixture layer was provided on both surfaces. In contrast, according to FIG. 8, the matter is apparent that the comparative electro-deposited copper foil used as the negative electrode current collector in deformation-comparative evaluation cell 1-1 generates wrinkles over the whole surface after one cycle of the charge/discharge operation, even the negative electrode mixture layer was provided on only one surface.

### 4-3 Evaluation as the Negative Electrode Current Collector of the Lithium Ion Secondary Battery

Table 2 shows evaluation results of the electro-deposited copper foils 1 and 3 and the comparative electro-deposited copper foil as the negative electrode current collectors of the lithium ion secondary batteries. As shown in Table 2, the electro-deposited copper foil 1 used as the current collector in Example 1 shows a minimum amount of wrinkles generated after one cycle of the charge/discharge operation in the deformation-evaluation cell 1-2. The cycle durability-evaluation cell 1 in which the electro-deposited copper foil 1 was used as the negative electrode current collector achieves a capacity maintenance rate of 90% after 50 cycles of the charge/discharge operation. Consequently, the electro-deposited copper foil 1 may have a quality level without practical problem as an electro-deposited copper foil for a negative electrode current collector of a lithium ion secondary battery. The electro-deposited copper foil 3 used as the current collector in Example 3 was wrinkle free after one cycle of the charge/discharge operation in the deformation-evaluation cell 3-2. The cycle durability-evaluation cell 3 in which the electro-deposited copper foil 3 was used as the negative electrode current collector achieves a capacity maintenance rate of 92% after 50 cycles of the charge/discharge operation. Therefore, the electro-deposited copper foil 3 may be very suitable as a current collector for a negative electrode current collector of a lithium ion secondary battery. In contrast, when the comparative electro-deposited copper foil as a current collector was used and carried out one cycle of the charge/discharge operation on deformation-comparative cell 1-2, wrinkles generate all over the surface. The capacity maintenance rate after 50 cycles of the charge/discharge operation on the cycle durability-comparative cell is 80%.

As described above, the matter is confirmed that deformation and fracture of the current collector is prevented even if the charge/discharge operation is repeated when a copper foil having “Value S” of 30 N or more was used as a current collector of a negative electrode of a lithium ion secondary battery.

TABLE 2

| | | | Comparative |
|---|---|---|---|
| | Example 1 | Example 3 | Example |
| Judgment | B | A | C |
| Deformation Ratio | 5% | 3% | 8% |
| after One Cycle of | | | |
| Charge/Discharge | | | |
| Operation | | | |
| Wrinkle Generation | Slight | Wrinkle | Wrinkles All |
| | Wrinkles | Free | Over Surface |
| “Value L” at Strain | 0.86 | 0.93 | 0.58 |
| Loaded of 30N | | | |
| Maintenance Rate | 90% | 92% | 80% |
| after 50 Cycles of | | | |
| Charge/Discharge | | | |
| Operation | | | |
| “Value S” | 32N | 40N | 19N |

### INDUSTRIAL APPLICABILITY

By using the copper foil according to the present invention as a current collector for a negative electrode of a lithium ion secondary battery, the current collector can follow the expansion/contraction of a negative electrode mixture layer even when a material such as Si or Sn having a large theoretical capacity is employed as a material to absorb lithium or to alloy with lithium for a negative electrode active substance and even if the negative electrode mixture layer greatly expands/contracts due to the charge/discharge operation. As a result, even if the charge/discharge operation is repeated, the current collector can be prevented from generating deformation such as wrinkles and fracture. Therefore, employment of the copper foil according to the present invention as a current collector for a negative electrode of a lithium ion secondary battery, a much higher energy density, a higher capacity and a long life can be achieved in a lithium ion secondary battery.

1. A copper foil for a negative electrode current collector of a lithium ion secondary battery,
wherein in the strain-stress curve obtained in the tensile test in which a 10 mm wide test specimen composed of the copper foil is used, a maximum strain loaded on the copper foil is 30 N or higher when “Value L” represented by the following expression (1) is 0.8 or more in a strain-stress curve obtained in the tensile test wherein the starting point of the curve is taken as O, and a point on the curve where the load at an elongation of E_{Q} is P_{Q} is taken as Q
$$\begin{matrix}[ Expression 3 ] & \\ Value L = \frac{( area of triangle {OQE}_{Q} )}{( area of region {OQE}_{Q} )} & ( 1 )\end{matrix}$$
wherein in the expression (1), the triangle OQE_{Q} indicates a triangle having corners at the starting point O, the point Q and the point E_{Q} in the stress-strain curve; and the region OQE_{Q} indicates a region surrounded by a curve OQ in the stress-strain curve, a line QE_{Q} and a line OE_{Q}.

2. The copper foil for the negative electrode current collector of a lithium ion secondary battery according to claim 1, wherein “Value L” is 0.8 or more when strain loaded on the test specimen is 30 N or less.

3. The copper foil for a negative electrode current collector of a lithium ion secondary battery according to claim 1, wherein a maximum strain loaded on the copper foil after heat treatment at 70° C. to 450° C. is 30 N or more when “Value L” is 0.8 or more.

4. A negative electrode material of a lithium ion secondary battery, including: a copper foil for a negative electrode current collector of a lithium ion secondary battery according to claim 1, the copper foil being used as a current collector; and a negative electrode mixture layer including a negative electrode active substance provided on a surface of the current collector.

5. The negative electrode material of a lithium ion secondary battery according to claim 4, wherein material including Si or Sn is used as the negative electrode active substance.

6. A method for selecting a negative electrode current collector of a lithium ion secondary battery to select a copper foil used for the negative electrode current collector of the lithium ion secondary battery, wherein the copper foil for a negative electrode current collector of a lithium ion secondary battery according to claim 1 is selected as a current collector among copper foils proposed.

7. The copper foil for a negative electrode current collector of a lithium ion secondary battery according to claim 2, wherein a maximum strain loaded on the copper foil after heat treatment at 70° C. to 450° C. is 30 N or more when “Value L” is 0.8 or more.

8. A negative electrode material of a lithium ion secondary battery, including: a copper foil for a negative electrode current collector of a lithium ion secondary battery according to claim 2, the copper foil being used as a current collector; and a negative electrode mixture layer including a negative electrode active substance provided on a surface of the current collector.

9. A negative electrode material of a lithium ion secondary battery, including: a copper foil for a negative electrode current collector of a lithium ion secondary battery according to claim 3, the copper foil being used as a current collector; and a negative electrode mixture layer including a negative electrode active substance provided on a surface of the current collector.

10. A negative electrode material of a lithium ion secondary battery, including: a copper foil for a negative electrode current collector of a lithium ion secondary battery according to claim 7, the copper foil being used as a current collector; and a negative electrode mixture layer including a negative electrode active substance provided on a surface of the current collector.

11. The negative electrode material of a lithium ion secondary battery according to claim 8, wherein material including Si or Sn is used as the negative electrode active substance.

12. The negative electrode material of a lithium ion secondary battery according to claim 9, wherein material including Si or Sn is used as the negative electrode active substance.

13. The negative electrode material of a lithium ion secondary battery according to claim 10, wherein material including Si or Sn is used as the negative electrode active substance.

14. A method for selecting a negative electrode current collector of a lithium ion secondary battery to select a copper foil used for the negative electrode current collector of the lithium ion secondary battery, wherein the copper foil for a negative electrode current collector of a lithium ion secondary battery according to claim 2 is selected as a current collector among copper foils proposed.

15. A method for selecting a negative electrode current collector of a lithium ion secondary battery to select a copper foil used for the negative electrode current collector of the lithium ion secondary battery, wherein the copper foil for a negative electrode current collector of a lithium ion secondary battery according to claim 3 is selected as a current collector among copper foils proposed.

16. A method for selecting a negative electrode current collector of a lithium ion secondary battery to select a copper foil used for the negative electrode current collector of the lithium ion secondary battery, wherein the copper foil for a negative electrode current collector of a lithium ion secondary battery according to claim 7 is selected as a current collector among copper foils proposed.
